(19) United States
(12) Patent Application Publication
(10) Pub. No.: US 2010/0223801 A1
(43) Pub. Date: Sep. 9, 2010

(54) A Lawnmower

(76) Inventor: David Honey, St. Andrews (GB)

Correspondence Address: Daniel P. Burke, Esq.;Daniel P. Burke & Associates, PLLC, 240 Townsend Square, Oyster Bay, NY, 11771, US

(21) Appl. No.: 12/223,261

(22) PCT Filed: Jan. 23, 2007
(86) PCT No.: PCT/GB2007/000220

§ 371 Date: Jul. 24, 2008

(30) Foreign Application Priority Data
Jan. 24, 2006 (GB) 0601389.0

(51) Int. Cl. F26B 19/00; A01D 43/063

(52) U.S. Cl. 34/90; 56/203; 165/51

(57) ABSTRACT

A lawnmower comprising a grass cutting unit (4,5). A grass collector (6) is positioned to receive grass from the grass cutting unit. The collector has an outlet (9) with a coupling for attachment to an external grass receiver and a mechanism (10) for removing grass from the collector through the outlet.

### BACKGROUND OF THE INVENTION

1. Field of the Invention

The present invention relates to a lawnmower.

2. Related Background Art

Traditionally, lawnmowers which cut the grass are provided with removable grass collectors. These are removed periodically and the collected grass tipped out into a composting area. This process is awkward and time-consuming and cannot be carried out by people who are unable to lift the full collector.

### SUMMARY OF THE INVENTION

According to the present invention, there is provided a lawnmower comprising a grass cutting unit; a grass collector positioned to receive grass from the grass cutting unit, and having an outlet with a coupling for attachment to an external grass receiver; and a mechanism for removing grass from the collector through the outlet.

In order to remove grass from the lawnmower of the present invention, it is simply a matter of connecting the coupling of the outlet to the external grass receiver and operating the removal mechanism. The lawnmower can therefore simply be pushed to the site where the grass is to be disposed of and, once there, there is no need to remove and lift the grass collector in order to empty it. The external grass receiver may, for example, be a storage device, composting device or a device to transfer grass to another site. The external grass receiver may be fixed or movable.

The mechanism for removing grass in its simplest form is manually operable. However, it is preferably automatically operable. The automatic mechanism may either be driven by a power supply on board the lawnmower, or alternatively, the lawnmower may be provided with a connector for an external power supply (e.g., mechanical or electrical) to drive the mechanism for removing grass.

The removal mechanism may take the form of a movable member within the collector which pushes the grass out of the outlet. Such a mechanism may, for example, be a plunger or an Archimedes screw. Alternatively or additionally, the removal mechanism may comprise a means for generating a flow of air to suck or blow the grass through the outlet.

Generally, when emptying a lawnmower, it is necessary to empty the grass onto the top of a compost heap. The outlet may therefore take the form of a flexible duct connected at one end to the grass collector and having the coupling at its opposite end. This flexible duct may therefore be connected to a complimentary coupling at the top of an external grass receiver containing the compost heap. The duct in this case would need to be stored on the lawnmower when not in use and therefore preferably has an expandable configuration which can be retracted for ease of storage.

As an alternative to providing an on-board duct, the duct may be provided externally to the lawnmower either attached to the grass receiver or as an entirely separate component. In this case, one end of the duct is arranged to mate with the coupling at the outlet of the grass collector. In order to alert the user that the grass collector requires emptying, the lawnmower preferably comprises a sensor which detects that a pre-determined amount of grass has entered the collector and an alarm which alerts the user to this condition.

The sensor may be any suitable sensor, for example, an optical sensor or a strain gauge. Alternatively, the collector is provided with a flexible plate which is deflected by the weight of grass, the alarm being arranged to be triggered when a pre-determined deflection of the plate is detected, for example, by a contact sensor or a proximity sensor.

Preferably, the lawnmower is provided with a dryer to dry the grass. This may be a blower and/or a heater. The heater may be arranged to heat the grass entering the grass collector, either by heating the grass once it is in the collector, or by heating the grass as it travels from the grass cutting unit into the grass collector. Such heating removes some of the moisture from the grass thereby reducing its volume and weight and allowing more grass to be stored in the collector. If the engine has an on-board combustion engine, the heater may use the heat generated by the engine either directly or indirectly via a heat exchanger.

Alternatively, the grass may be heated as it leaves the outlet of the grass collector. This aids the composting process and reduces the volume and weight of the grass in the grass store. The present invention also extends to a combination of a lawnmower and a grass receiver, the grass receiver having engaging means to receive the coupling.

The receiver forms an independent aspect of the invention in its own right which can be described in the broadest sense as grass receiver having a chamber for receiving grass and an engagement means for attachment to a coupling on a lawnmower, wherein, in use, grass is arranged to enter the chamber via the engagement means.

The receiver may be provided with additional devices to treat the grass such as a heater, grass agitator or chemical dispenser to dispense grass treatment chemicals.

These may either be powered with their own power supply or may be arranged to receive energy from a source external to the grass receiver, and the receiver has a connector for attachment to the source.

According to a further aspect of the invention, there is provided a lawnmower comprising a grass cutting unit, a grass collector positioned to receive grass from the grass cutting unit, and a heater for heating the grass.

By heating the grass, its weight and volume is reduced, thereby allowing more grass to be stored in the collector or an external grass receiver.

The heater may be arranged to heat the grass on its way into the collector, while it is in the collector, on its way out of the collector or any combination of these. If the lawnmower has a combustion engine, this can be used to provide the heat for the heater. The heat may be either taken from the exhaust gas, or from an engine coolant.

Alternatively, if the lawnmower is an electric lawnmower, the heater may be electric.

### BRIEF DESCRIPTION OF THE DRAWINGS

An example of a lawnmower constructed in accordance with the present invention will now be described with reference to the accompanying drawings, in which:

FIG. 1 is a schematic side view of the lawnmower;

FIG. 2 is a plan view of the lawnmower; and

FIG. 3 is a cross-sectional view along line III-IIIin FIG. 2.

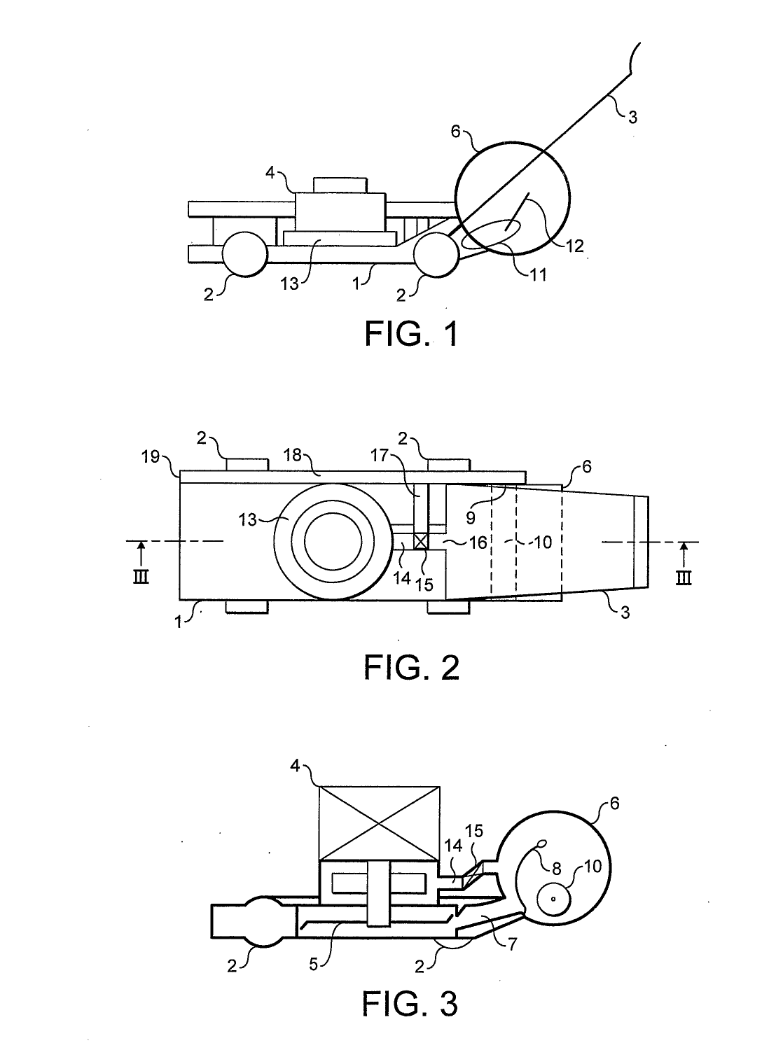

### DETAILED DESCRIPTION OF THE PREFERRED EMBODIMENT

The illustrated lawnmower is adapted from a conventional petrol-driven lawnmower. The lawnmower has a chassis 1 with wheels 2 and a handle 3. A petrol-driven engine 4 drives a rotary blades 5 to cut the grass.

It will be appreciated, however, that the invention is equally applicable to any lawnmower which has a device (e.g., a bag or drum) for collecting grass. The invention may therefore be applicable to manually-driven mowers as well as automatic mowers. It can be applied to hover mowers as well as rotary mowers. It can be applicable to small push-along mowers and larger “ride-on” mowers. What is achievable for a particular mower will depend to a large extent on whether there is an on-board power supply available, the size of this power supply, and also on the lawnmower's capacity for grass collection.

The adaptations to the traditional lawnmower are described below.

The conventional grass collector is replaced by a grass collecting drum 6. This may be a rigid container or a flexible bag. The drum is permeable to air. Either it is made of a mesh like material, or is provided with a number of holes at discrete locations to allow for a through flow of air. The drum is fixed to the chassis 1 and does not need to be as readily removable as a conventional grass collector. However, the drum is preferably removable for periodic maintenance and cleaning, which may only need to be done two or three times a year. Thus, the drum 6 should be attached to the chassis 1 using a number of quick release fasteners. The drum has an inlet 7 to receive grass thrown up by the blades 5. This grass is thrown up over a flexible plate 8 extending upwardly from behind the inlet 7. As the lawnmower is used, the space to the right of the flexible plate 8 (as shown in FIG. 3) is filled with grass and the weight of the grass deflects the plate to the left. The plate 8 serves to separate the incoming grass from the grass already in the drum to minimise blockages in the inlet area. The plate 8 is arranged such that when the drum 6 contains sufficient grass that it requires emptying, plate 8 comes into contact or close proximity with the left-hand wall of the drum 6. This triggers a sensor which then activates a visual or audio alarm to alert the user to empty the drum.

Once the drum is emptied, the plate returns under its own resilience towards the starting position shown in FIG. 3. The drum 6 has an outlet 9 through which grass is expelled from the drum. An Archimedes screw 10 extends across the bottom of the drum and leads to the outlet 9. The Archimedes screw 10 is operated by a drive mechanism 11 which is connected via suitable gearing to the engine 4. A lever 12 is operated by the user in order to engage the drive of the Archimedes screw. This causes the Archimedes screw to rotate to expel the grass through the outlet 9.

To aid with the expulsion of the grass, a fan-driven suction mechanism is also provided. This takes the form of a fan 13 driven by the engine 4. This generates an airflow through a duct 14 leading to a valve 15. From the valve 15 a filling duct 16 leads to the drum 6 and an emptying duct 17 is provided as described below. When the lawnmower is in normal use, the valve 15 is positioned to allow flow through the filling duct 16 thereby generating an airflow into the drum 6 to assist with the grass collection. When the drum is to be emptied, the valve 15 is switched to an emptying position whereupon the airflow from the fan 13 is diverted along emptying duct 17. This leads to an outlet duct 18 via a venturi 19 which creates suction in the outlet duct 18 to assist with the removal of the grass from the drum 6 through the outlet 9. The outlet duct 18 has an outlet 19 through which the grass is expelled.

The outlet 19 is provided with a coupling which is designed to be complimentary with a mating coupling of a compost heap. The outlet duct 18 may be flexible so that it can be moved from the position shown to allow the outlet 19 to reach a raised inlet towards the top of the compost heap. It will be appreciated that the suction mechanism is described in combination with the Archimedes screw 10 but either of these two devices can be used alone to empty the drum 6.

Exhaust gas from the petrol engine 4 may be used to provide heating of the grass in the drum 6. This can be done either by routing the exhaust gas through the duct 14 directly, or by bringing an exhaust duct into contact with the duct 14 to enable heat transfer into the duct 14. The mower can be provided with a valve system (not shown) to enable the heat from the exhaust gas either to be supplied to the grass on its way into the drum 6, or once it is in the drum 6, or on its way out of the drum.

1. A lawnmower comprising a grass cutting unit, a grass collector positioned to receive grass from the grass cutting unit, an outlet with a coupling for attachment to an external grass receiver; and a mechanism for removing grass from the collector through the outlet.

2. (canceled)

3. (canceled)

4. A lawnmower according to claim 1, further comprising an on-board power supply, wherein said mechanism for removing grass is automatically operable and is driven by said power supply on-board the lawnmower.

5. (canceled)

6. A lawnmower according to claim 1, wherein the mechanism for removing grass comprises a movable member within the collector which pushes the grass out through the outlet.

7. A lawnmower according to claim 6, wherein the movable member comprises an Archimedes screw.

8. A lawnmower according to claim 1, wherein the mechanism for removing grass comprises a means for generating a flow of air to suck or blow the grass through the outlet.

9. A lawnmower according to claim 1, wherein the outlet comprises a flexible duct connected at one end to the grass collector and having the coupling at its opposite end.

10. (canceled)

11. (canceled)

12. A lawnmower according to claim 1, further comprising a sensor which detects that a pre-determined amount of grass has entered the collector and an alarm which alerts the user to this condition.

13. A lawnmower according to claim 1, wherein the collector comprises a flexible plate separating incoming grass from stored grass and wherein said flexible plate is movable in response to the weight of stored grass.

14. (canceled)

15. A lawnmower according to claim 1, further comprising a dryer to dry the grass.

16. A lawnmower according to claim 15, wherein said dryer comprises a heater.

17. (canceled)

18. (canceled)

19. (canceled)

20. (canceled)

21. (canceled)

22. (canceled)

23. (canceled)

24. (canceled)

25. (canceled)

26. (canceled)

27. A lawnmower comprising a grass cutting unit, a grass collector positioned to receive grass from the grass cutting unit, and a dryer for drying the grass.

28. (canceled)

29. (canceled)

30. (canceled)

31. A lawnmower according to claim 27, further comprising a combustion engine, wherein said dryer comprises a heater supplied with heat recovered from the engine.

32. A lawnmower according to claim 31, wherein the heater is supplied with heat from the exhaust gas from the engine.

33. A lawnmower according to claim 31, wherein a coolant is provided to remove heat from the combustion engine, and wherein the heater is supplied with heat from the coolant.

34. A lawnmower according to claim 27, further comprising an electrical connection for connecting to an electricity supply, wherein said dryer comprises an electric heater.

35. A lawnmower according to claim 32, wherein a coolant is provided to remove heat from the combustion engine, and wherein the heater is supplied with heat from the coolant.

36. A lawnmower according to claim 31, wherein exhaust gas from said engine is used to heat the grass.

37. A lawnmower according to claim 4, wherein the mechanism for removing grass comprises a movable member within the collector which pushes grass out through the outlet.
